(19) United States
(12) Patent Application Publication
(10) Pub. No.: US 2009/0324470 A1
(43) Pub. Date: Dec. 31, 2009

(54) Process for Optimizing the Catalytic Activity of a Perovskite-Based Catalyst

(75) Inventors: Houshang Alamdari, Ste-Foy (CA); Mahbod Bassir, Cap-Rouge (CA); Purnesh Seegopaul, Flemington, NJ (US); André Van Neste, Ste-Foy (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Nanox Inc.

(21) Appl. No.: 12/304,697

(22) PCT Filed: Jun. 12, 2007
(86) PCT No.: PCT/CA2007/001049

§ 371 Date: Dec. 12, 2008

(30) Foreign Application Priority Data
Jun. 12, 2006 (US) 60812633

(51) Int. Cl. B01D 53/94; B01J 23/02; B01J 23/10; B01J 21/02; B01J 21/08

(52) U.S. Cl. 423/213.2; 502/340; 502/304; 502/242; 502/202

(57) ABSTRACT

The present invention relates to a process for producing an activated perovskite-based washcoat formulation suitable for reduction of carbon monoxide, volatile organic compounds, particulate matter, and nitrogen oxides emissions from an exhaust gas stream. The process includes the steps of high energy ball milling a fully synthesized perovskite structure to provide an activated nanocrystalline perovskite powder of a given surface area; mixing the activated nanocrystalline perovskite powder with dispersing media and grinding the mixture; removing partially or totally the dispersing media to obtain an activated perovskite-based catalyst washcoat formulation wherein the activated perovskite in the formulation has a specific surface area greater than that of the activated nanocrystalline perovskite powder. The process may further include a step of applying the formulation on a substrate to obtain a catalytic converter. The invention also relates to the activated nanocrystalline perovskite, the activated perovskite-based catalyst washcoat formulation, and the catalytic converter obtained thereby.

### FIELD OF THE INVENTION

The present invention relates generally to catalysts and processes for manufacturing catalyst formulations for the catalytic removal of exhaust gas emissions, such as, volatile organic compounds (VOC), carbon monoxide (CO), nitrogen oxides (NOx) and particulate matter (PM) for both mobile and stationary applications. Such catalysts can also be used for fuel reforming and Fischer-Tropsch processes. More particularly, it concerns an activation process for increasing the catalytic activity of a perovskite-type catalyst, and the products obtained from having a nanocrystalline hierarchical structure. This activation process is particularly useful in facilitating enhanced catalytic performance at low temperatures that are important in environmental emission control, including mobile sources, such as automotive vehicles, and stationary sources, such as, power plants.

### BACKGROUND OF THE INVENTION

Heterogeneous catalysis in use today is an efficient method to reduce the critical air pollutants, with the platinum group metals (PGM) suite of platinum (Pt), palladium (Pd) and Rhodium (Rh) being the catalysts of choice. However, this situation is complicated by the escalating and erratic PGM pricing coupled with the demand for higher performance at lower costs. The tougher environmental regulations require higher catalytic efficiency and productivity and lead to higher levels of PGM usage, with the resulting cost increases. As a result, there is a deep interest to lower the level of PGM usage and implement significantly reduced PGM catalyst formulations or come up with alternative non-PGM catalyst formulations.

Many control initiatives are being employed and evaluated to meet emissions environmental standards. These technologies include diesel particulate filters (DPF), catalyzed DPF (CDPF), catalyzed soot filters (CSF), continuously regenerating traps (CRT®) with selective catalytic reduction (SCR), lean NOx traps (LNT), NOx adsorber catalysts (NAC), fuel-borne catalysts (FBC), and exhaust gas recirculation (EGR).

Technologies based on the absence or significantly reduced levels of PGM are also now available to both complement and strengthen the emission control technologies. These include the use of active nanomaterials, computer modeling to allow strategic placement of PGM particles for reduced usage rate, platinum (Pt)-palladium (Pd) combinations, Pd-loaded perovskites, and improved precious metal thrifting.

It is well established that perovskites with the general formula ABO_{3±δ} exhibit catalytic activity with respect to oxidation reactions, with the performance linked to the nature and valence states of the A and B ions. A great number of elements can be chosen for A and B and a large number of compounds can fall within the scope of the term perovskite. Perovskite-type oxides are well described in the art. For example, the general chemical composition and crystalline structure of known perovskites are given in a number of publications and patents such as U.S. Pat. No. 6,531,425 B2, U.S. Pat. No. 4,134,852 and U.S. Pat. No. 6,017,504. Perovskite-type oxides can be manufactured by a number of chemical or physical methods such as heat treatment (ceramic method), crystallization of an amorphous compound, co-precipitation followed by heat treatment, sol-gel, mechanosynthesis, etc. However, despite many years of research, application of perovskite-based catalysts has been limited because of both non-competitive performance from un-optimized material structures and high levels of sulfur in the fuel streams. A solution to this problem is the use of nanostructured perovskite-based Nanoxite™ catalysts engineered with unique structural features and high surface areas that enable higher catalytic efficiency at lower temperatures without sacrificing durability performance. Nanoxite is a “catalytic washcoat” product in that it simultaneously functions as the emission control catalyst while providing the bulk of the washcoat. As a result, both the PGM level and the amount of conventional washcoat materials are simultaneously reduced. Use of these formulations is now greatly facilitated by the mandated sulfur reduction in diesel fuels.

Regardless of the preparation method, perovskite-type oxides show some catalytic activity for the above-mentioned reactions. However, the activity for a given chemical composition may be different from one method to another. One of the most important factors in a catalyst material is the composition of the catalyst. Apart from the chemical composition, the crystalline structure, particle size, particle morphology, as well as the porosity and specific surface area are factors influencing the catalyst performance. It is also believed that structural defects could influence the oxygen mobility within the catalyst structure and consequently the catalytic activity. The effect of particle morphology is, however, difficult to characterize. It is believed that the edges and corners on the surface of a particle are the points with higher chemical potentials. So, the edges and corners are the potential catalytic sites. The number of edges and corners, in general, increases as the particle size decreases, especially when the particle size reaches the nano-scale (typically less than 10 nm). On the other hand, for a given particle size, the number of edges and corners may depend on the preparation method. In addition, the finer particles or porous materials result, in general, in a higher specific surface area. Since the catalytic reactions occur on the surface, the finer particles or porous materials have more available surface for the reactions resulting in a better catalytic activity. It is therefore the objective of catalyst development to provide particles or crystallites of perovskite with a low as possible size and a high as possible specific surface area.

Most of the perovskite manufacturing techniques comprise two steps: a) providing a mixture of the starting ingredients or precursors of the ingredients and b) heat treating the mixture to provide a solid state reaction and finally a perovskite structure. In the ceramic method, for example, the starting oxides are mixed and heat treated at high temperature to provide the perovskite structure. The problem encountered with this method is that the high temperature treatment enhances the grain growth resulting in a coarse-grained perovskite which is not suitable for catalytic purposes. In order to prevent the grain growth, the temperature and time of heat treatment must be decreased.

Perovskite manufacturing techniques such as co-precipitation, citrate method or sol-gel allow synthesizing perovskite at much lower temperatures and shorter process times. These techniques provide a mixture of the precursors wherein the precursors are very intimately mixed at the molecular or nano scale thereby facilitating the reaction between the ingredients. It is therefore possible to synthesize a perovskite with small crystallite size and relatively high surface area.

Mechanosynthesis is an alternative technique for synthesizing alloys and compounds without high temperature treatment. Kaliaguine et al. (U.S. Pat. No. 6,770,256B1) showed that perovskite-based materials could be synthesized by high energy ball milling. This technique results in very angular particles that are highly agglomerated, the agglomerates having a relatively small specific surface area. Although ball milled materials have a good potential to be efficient catalysts, the usually small effective surface area of these materials presents a barrier for their use in catalytic applications.

Schulz et al (U.S. Pat. No. 5,872,074) used a clever way to increase the specific surface area of a metastable composite or alloy using high energy ball milling. They prepared a nanocrystalline material consisting of a metastable composite of at least two different chemical elements by high-energy ball milling. Then, they removed one of the elements by leaching to obtain a porous structure with high specific surface area (higher than 2 m²/g). This metastable nanocrystalline material could be used for hydrogen storage, as a catalyst for fuel cells or in several other applications.

Kaliaguine et al. used the above technique to increase the specific surface area of mechanosynthesized perovskites. They disclose the mechanosynthesis of perovskite by high energy ball milling in U.S. Pat. No. 6,017,507. In order to increase the specific surface area of mechanosynthesized perovskite, the powder is subjected to another high-energy milling step where the powder is mixed with a leachable agent which is removed in a subsequent step. A specific surface area of greater than 40 m²/g is obtained with this method.

The effect of this increase in specific surface area on the catalytic activity is not discussed in these patents and the disclosed process or product was not related to a specific application. Both Schulz and Kaliaguine disclose the milling/leaching technique to increase the specific surface area of a nanocrystalline powder (metallic powder or perovskite) which is prepared by high-energy ball milling, i.e. mechanosynthesis.

Although the existing methods provide fine-grained perovskite with relatively high specific surface area, the resulting products are still not ideal for catalytic application. The problem encountered with these techniques is related to the presence of un-reacted ingredients and the compromise between the synthesis completion, particle size and surface area. A small amount of un-reacted ingredients could be harmful for hydro-thermal stability and durability of the perovskite-based catalysts. In order to complete the synthesis and reduce the residual un-reacted ingredients in the conventional methods, the time and temperature of synthesis must be increased. This tends to increase the crystallite size and decrease the specific surface area, and consequently the catalytic activity is decreased. In the mechanosynthesis method, on the other hand, the grain growth is not an issue. However, it is difficult by this method to reach a full synthesis and provide a product almost free from the starting ingredients. In order to decrease the amount of the residual ingredients, the process time must be very high—especially knowing that, as the reaction progresses, the synthesis becomes more difficult while the level of contamination increases. In addition, the small fraction of the residual ingredients is not easily detectable by X-ray or other analytical methods and this makes control of the process complicated. Since high energy ball milling is an expensive technique, increasing the process time to reduce or eliminate the un-reacted ingredients results in a very high production cost which does not justify the use of such a product for catalysis purposes.

### SUMMARY OF THE INVENTION

One objective of the present invention is to provide a process for producing lower cost, higher performance perovskite catalysts and/or perovskite-based catalyst washcoat formulations which overcome several of the above mentioned drawbacks.

More particularly, the present invention provides a process for producing an activated perovskite-based catalyst washcoat formulation suitable for reduction of CO, VOC, PM and NOx emissions from an exhaust gas stream. The process includes the steps of:

a) subjecting a fully synthesized perovskite structure to high energy ball milling to provide an activated nanocrystalline perovskite in powder form, the activated nanocrystalline perovskite having a given surface area;
b) mixing the activated nanocrystalline perovskite in powder form with dispersing media to produce a mixture and grinding the mixture for dispersing the activated nanocrystalline perovskite in the dispersing media;
c) removing partially or totally the dispersing media by a chemical or a physical method so as to obtain the activated perovskite-based catalyst washcoat formulation, the activated perovskite-based catalyst washcoat formulation containing an activated perovskite having an increased specific surface area relative to the given surface area of the activated nanocrystalline perovskite obtained in step a).

As can be appreciated, the process according to the invention can also be described as an activation process to activate a coarse-grained perovskite-type powder free from un-reacted ingredients in order to increase its catalytic activity and its hydrothermal durability. The expression “activated catalyst” designates a catalyst being subjected to the activation process described in this invention and having an activity higher than that it had before the activation process.

The process may include an additional step before step a) of providing an intimate mixture of starting precursors suitable for synthesis of perovskite and subjecting the mixture to high temperature heat treatment to obtain the fully synthesized perovskite structure.

According to one embodiment of the process, steps a) and b) may be combined and the operation performed with a vertical high energy ball mill.

As mentioned above, the process according to the present invention provides lower cost, higher performance activated perovskite catalyst formulations, and catalysts as such, while addressing many of the abovementioned disadvantages of the existing techniques relating to residual un-reacted ingredients, high contaminant levels or high product cost. Strictly speaking, according to the process proposed in this invention, a perovskite, substantially free from residual ingredients and regardless of its surface, morphology or grain size, may be used to provide a nanocrystalline perovskite-based catalyst having high specific surface area, high catalytic activity, and suitable structure and morphology for effective use as catalysts in emissions control.

Through their present work, the inventors have discovered that the specific surface area is not the only parameter influencing the catalytic activity of a perovskite with a given chemical composition, and that the particle size, particle structure and morphology are also important parameters which determine catalyst performance.

Thus, the present invention also concerns a washcoat formulation obtained according to the process defined above. The activated perovskite-based catalyst washcoat formulation preferably has a catalytic activity to convert CO to CO₂, in the presence of oxygen, at a temperature lower than 150° C.

The process defined above may also include a step d), after step c), of applying the activated perovskite-based catalyst washcoat formulation on a metallic or ceramic substrate to obtain a perovskite-based catalytic converter, and the present invention is also directed to the perovskite-based catalytic converter obtained according to the process defined above. The perovskite-based catalytic converter includes a support structure covered with an activated perovskite-based catalyst washcoat formulation as defined above.

The perovskite-based catalytic converter may be used for catalytic reduction of emissions from a diesel engine exhaust gas stream and/or for catalytic conversion of VOC, methane, NOx or PM, or of any combination thereof.

In accordance with a further aspect of the present invention, there is provided an activated nanocrystalline perovskite in powder form obtained according to the process defined in step a). The activated nanocrystalline perovskite has a general chemical composition represented by the general formula:

A₁₋ₓA′ₓB_{1-(y+z)}B′_{1-(y+z)}M_{z}O₃

where A is La, Sr, Pr, Gd or Sm and A′ is a substitution element selected from the group of elements consisting of Ca, K, Ba, Sr, Ce, Pr, Mg, Li and Na; B and B′ are tetravalent, divalent or monovalent cations selected from the group of elements consisting of Co, Mn, Cu, Fe, Ti, Ni, Zn, Cr, V, Ga, Sn, Y, Zr, Nb, Mo, Ag, Au and Ge; M is selected from the group of platinum metals consisting of Ru, Rh, Pd, Os, Ir, and Pt; and X and Y vary between 0 and 0.5 and Z varies between 0 and 0.1.

### BRIEF DESCRIPTION OF THE DRAWINGS

Further aspects and advantages of the invention will be better understood upon reading the description of preferred embodiments thereof with reference to the following drawings:

FIG. 1 is a graph showing the X-ray diffraction (XRD) patterns of La_{0.9}Ce_{0.1}CoO₃ perovskites prepared by three different methods.

FIG. 2 is a graph showing the temperature programmed desorption (TPD) of oxygen patterns of La_{0.9}Ce_{0.1}CoO₃ perovskites prepared by three different methods.

FIG. 3 is a graph showing the activity, in terms of conversion rate versus temperature, of La_{0.9}Ce_{0.1}CoO₃ perovskites prepared by three different methods.

FIG. 4 is a graph showing the effect un-reacted raw materials on the stability of perovskite.

FIG. 5 is a graph showing the catalytic oxidation of three Volatile Organic compounds (VOCs) using Pt-free Nanoxite EC1 powder.

### DETAILED DESCRIPTION OF PREFERRED EMBODIMENTS THE INVENTION

### Activation Process

In general, the activation process of the present invention may be used to activate a coarse-grained perovskite-type powder, which is substantially free from un-reacted ingredients, in order to increase its catalytic activity and its hydrothermal durability.

The expression “activated catalyst” designates a catalyst being subjected to the activation process described in this invention and having an activity higher than that it had before the activation process.

More specifically, in accordance with one aspect of the present invention there is provided a process for producing an activated perovskite-based catalyst washcoat formulation suitable for reduction of carbon monoxide (CO), volatile organic compounds (VOC), particulate matter (PM) and nitrogen oxides (NOx) emissions from an exhaust gas stream.

The expression washcoat is well established in the catalyst industry. It typically means a mixture of metal oxides, primarily aluminium oxide, used to provide a high surface area coating on the substrate (ceramic or metallic). The catalyst is then commonly impregnated onto the washcoat layer. However in some cases, as in the present invention, the catalyst already forms part of the washcoat slurry so that both washcoat and catalyst are deposited in a single step.

As mentioned above, the process basically includes steps a), b) and c) of a) activation of a perovskite structure, b) mixing with a dispersing media and c) obtaining the washcoat formulation described hereinbelow.

### a) Activation of a Perovskite Structure

In this step, a fully synthesized perovskite structure is subjected to high energy ball milling to provide an activated nanocrystalline perovskite in powder form and of a given surface area.

The process may include an additional step before step a) of providing an intimate mixture of starting precursors suitable for synthesis of perovskite and subjecting the mixture to high temperature heat treatment. The mixture of starting precursors may be provided by co-precipitation, citrate method, sol-gel method, or ball milling of oxide ingredients. The high temperature heat treatment of the mixture of starting precursors may be performed under air and at temperatures between 700 and 1200° C.

High energy ball milling of the fully synthesized perovskite structure of may be performed using a horizontal high energy ball mill, preferably operating at a speed in the range of 50 to 1000 revolutions per minute (rpm) for a period of time ranging from 1 to 7 hours (h). Alternatively a vertical high energy ball mill may be used.

Through high energy ball milling, the large crystals of perovskite structure provided in step a) are broken down into nanosize particles to provide an activated nanocrystalline perovskite in powder form. The breaking and welding of particles during milling results in a hierarchical structure of polycrystals comprising individual nanocrystallites with high density of grain boundaries and oxygen mobility (see Example 1 hereinbelow). The mean particle size of the polycrystals can vary between a fraction of a micron (μm) and several tens of microns while the mean individual crystallite size is less than 100 nm, more preferably less than 30 nm.

At least one additive may be added in this step of high energy ball milling to enhance the process. The additive may be selected from the group of compounds including but not limited to CeO₂, Al₂O₃, B₂O₃, SiO₂, V₂O₃, ZrO₂, Y₂O₃, stabilized ZrO₂, CeZr solid solution. Of course any suitable related materials or mixtures thereof, including a combination of any of the compounds indicated earlier, may be used as an additive.

b) Mixing with a Dispersing Media

The activated nanocrystalline perovskite in powder form is then mixed with dispersing media and ground to disperse the activated nanocrystalline perovskite in the dispersing media.

Grinding may be carried out using any known blending technique capable of breaking the activated polycrystals and dispersing them in the dispersing media, for example wet/dry ball milling using a vertical high energy ball mill. The dispersing media can be water, or include alcohols, amines or any other compatible solvents, such as a combination of water and triethanolamine (TEA). The dispersing media is preferably 5 to 60 wt % of total charge. The product obtained after the grinding may sometimes be referred to hereinbelow as a slurry.

Alternatively, step a) and step b) above may be combined and the high energy ball milling of step b) and the grinding of step c) may be carried out using a vertical high energy ball mill, wherein the vertical ball mill operates at 150 to 500 rpm. The high energy ball milling and grinding preferably occur over a period of time ranging from 3 to 10 hours.

### c) Obtaining the Washcoat Formulation

The washcoat formulation is obtained by removing partially or totally the dispersing media by a chemical or a physical method. The washcoat formulation obtained is said to be activated as it contains an activated perovskite having an increased specific surface area relative to the given surface area of the activated nanocrystalline perovskite obtained in step a).

The dispersing media may be partially or totally removed from the slurry resulting from step b) through drying and calcination to provide an activated perovskite-based catalyst washcoat formulation, in powder form.

The process may further include an additional step of: d) applying the activated perovskite-based catalyst washcoat formulation on a metallic or ceramic substrate to obtain a perovskite-based catalytic converter.

Indeed, the activated perovskite-based catalyst washcoat powder formulation obtained in step c) can be washcoated onto metal or ceramic substrates to make a catalytic converter. Furthermore, the slurry obtained in step b) can also be treated and applied directly to the ceramic and/or metallic substrates, thereby eliminating the drying process. Of course, the activated perovskite-based catalyst washcoat formulation may be washcoated onto a support structure such as a ceramic or metallic honeycomb.

### Catalysts and Catalytic Converter

As mentioned above, the present invention is also directed to an activated nanocrystalline perovskite. The activated nanocrystalline perovskite is a powder obtained according to step a) of the process defined above, that is by subjecting a fully synthesized perovskite to high energy ball milling. The activated perovskite-based catalyst has a general chemical composition represented by the general formula:

A₁₋ₓA′ₓB_{1-(y+z)}B′_{1-y}M_{z}O₃

where A is La, Sr, Pr, Gd or Sm and A′ is a substitution element selected from the group of elements consisting of Ca, K, Ba, Sr, Ce, Pr, Mg, Li and Na; B and B′ are tetravalent, divalent or monovalent cations selected from the group of elements consisting of Co, Mn, Cu, Fe, Ti, Ni, Zn, Cr, V, Ga, Sn, Y, Zr, Nb, Mo, Ag, Au and Ge;
M is selected from the group of platinum metals consisting of Ru, Rh, Pd, Os, Ir, and Pt; and
X and Y vary between 0 and 0.5, and Z varies between 0 and 0.1.

The group of platinum metals consisting of ruthenium (Ru), rhodium (Rh), palladium (Pd), osmium (Os) iridium (Ir), and platinum (Pt) is also often referred to as the platinum group, the platinum group metals (PGM) or platinum metals. These elements are transition metals with similar physical and chemical properties. The catalytic properties of platinum (Pt), palladium (Pd) and rhodium (Rh) tends to make them the elements of choice.

Preferably, the activated perovskite-based catalyst has a chemical composition of La_{0.6}Sr_{0.4}CO_{0.99}MO_{0.01}O₃ where M is an element from the platinum group metals.

The activated nanocrystalline perovskite may be in a powder form with a mean crystallite size of less than 100 nm, as determined by X-ray diffraction methods. The activated perovskite-based catalyst powder may preferably have a particle size ranging from 0.04 to 100 microns, as obtained by laser diffraction method, and a specific surface area in the range of 2 to 10 g/m².

The invention is also directed to an activated perovskite-based catalyst washcoat formulation obtained according to the process defined above. The activated perovskite-based catalyst washcoat formulation obtained has a specific surface area that is greater than that of the activated nanocrystalline perovskite obtained in step a). Advantageously, the activated perovskite-based catalyst washcoat formulation can have a specific surface area varying between 10 and 200 m²/g and a catalytic activity to convert CO to CO₂, in the presence of oxygen, at a temperature lower than 150° C.

In accordance with another aspect of the present invention, there is also provided a perovskite-based catalytic converter obtained according to the process described above. The catalytic converter can be produced by applying, for example using a washcoating technique, the activated perovskite-based catalyst washcoat formulation on a substrate or any support structure. The substrate or support is preferably metallic or ceramic, but of course it may be made of any suitable material. To increase the active surface area of the catalytic converter, the support structure may be honeycombed.

The activated perovskite-based catalytic converter may be used for catalytic reduction of emissions from a diesel engine exhaust gas stream. It may also be used for catalytic conversion of VOC, methane, NOx or PM, or any combination thereof.

### EXAMPLES

The following non-limiting examples illustrate the invention. These examples and the invention will be better understood with reference to the accompanying figures.

### Example 1

In this example the XRD diffraction pattern of three samples are compared.

### Sample A (Ceramic Method):

La_{0.9}Ce_{0.1}CoO₃ perovskite obtained by ceramic method where the stoichiometric amounts of La₂O₃, CeO₂, Co₃O₄ were pre-mixed in a vertical attritor for 1 hour and the resulting mixture was subjected to a heat treatment at 1000° C. under air for 3 hours to obtain the perovskite structure.

### Sample B (Citrate Method):

La_{0.9}Ce_{0.1}CoO₃ perovskite obtained by citrate method. The co-precipitated mixture was dried and calcined at 730° C. for 12 hours to obtain the perovskite structure.

### Sample C (Present Invention):

La_{0.9}Ce_{0.1}CoO₃ perovskite was obtained by the same ceramic method as for Sample A. The perovskite obtained was then subjected to high energy horizontal ball milling for 3 hours. The horizontal high energy ball mill was operating at 500 rpm with a ball to powder ratio of 8:3. The resulting powder was then subjected to a further wet grinding in a vertical attritor for 7 hours, followed by oven drying at 120° C.

As can be appreciated, sample C was prepared according to one embodiment of the process according to the invention. Indeed, the step of preparing the La_{0.9}Ce_{0.1}CoO₃ perovskite by ceramic method followed by high energy ball milling corresponds to the activating of a perovskite structure (step a)), the step of further wet grinding the resulting powder in a vertical attritor corresponds to step b) of mixing with a dispersing media, wherein the dispersing media is water, and the step of oven drying at 120° C. corresponds to step c) of the process of the invention.

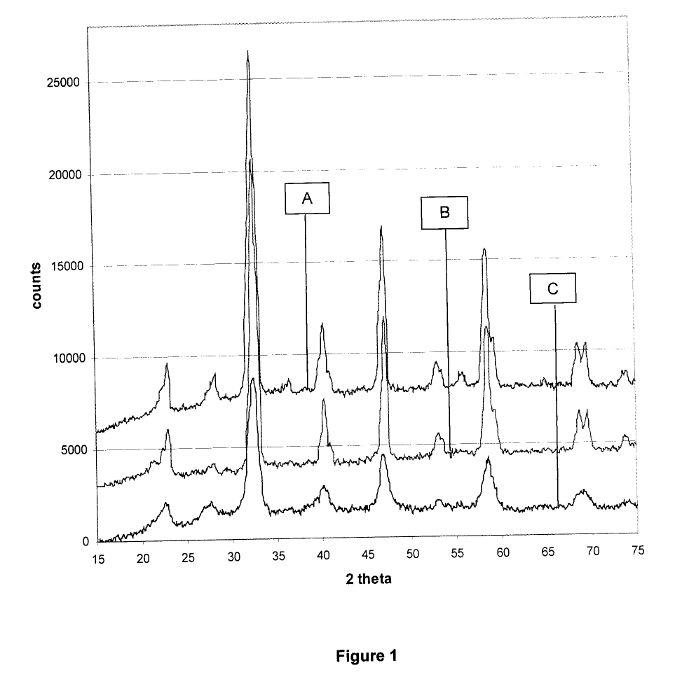

FIG. 1 shows the XRD patterns of perovskite samples (A, B, and C) prepared by these three methods.

### Example 2

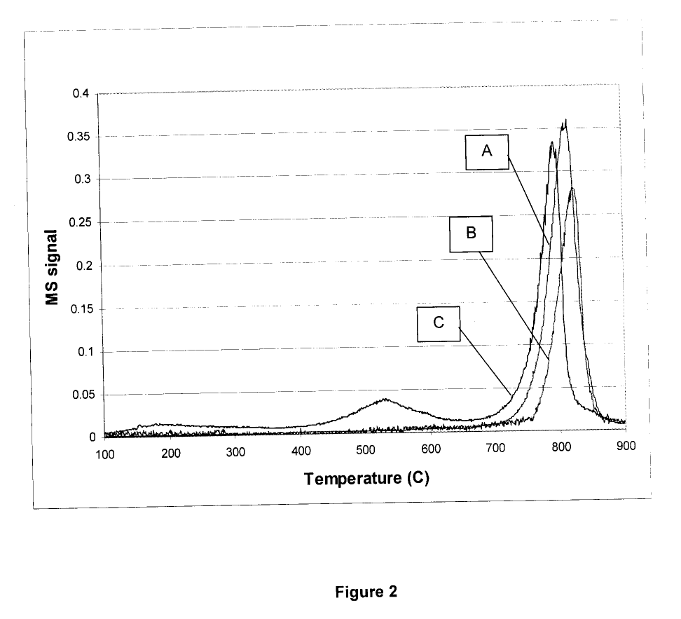

In this example the TPDO (temperature programmed desorption of oxygen) pattern of three samples according to Example 1 are compared (FIG. 2).

### Example 3

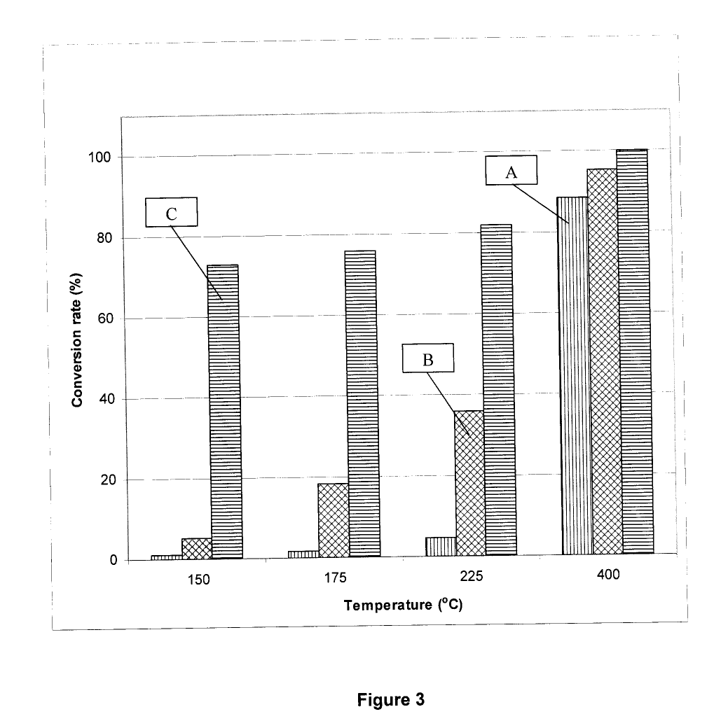

In this example the catalytic activity of three samples according to Example 1 are compared at different temperatures (FIG. 3). The samples were tested under a gas stream with 50 000 h⁻¹ space velocity. The composition of gas stream was:

| | |
|---|---|
| C3H6: | 200 ppm |
| CO: | 2000 ppm |
| O2: | 20% |
| H2O: | 10% |
| Inert gas: | Balance |

### Example 4

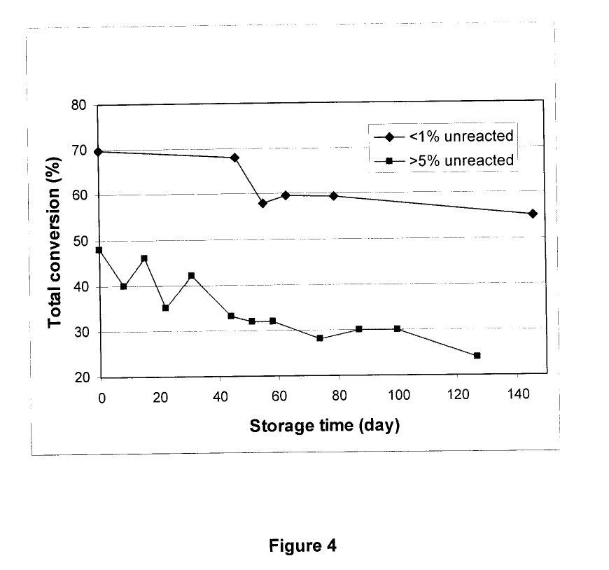

This example shows the effect of the unreacted ingredients on the activity and stability of a La_{0.9}Ce_{0.1}CoO₃ perovskite. The test conditions are the same as specified in Example 3 (FIG. 4).

### Example 5

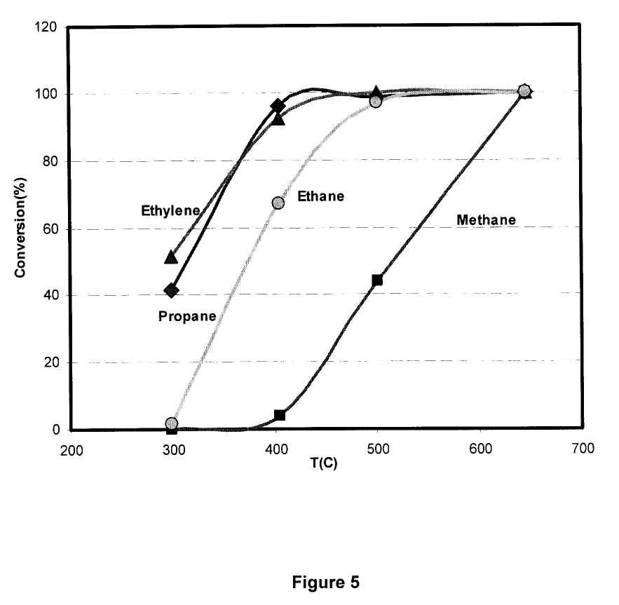

FIG. 5 shows the catalytic activity of activated La_{0.6}Sr_{0.4}CoO₃ catalyst in powder form for oxidation of some VOC. The catalyst in powder form was prepared as described in Example 1 (Sample C—Invention Method). The gas composition used in this example was

| | | |
|---|---|---|
| Methane: | 1000 | ppm |
| Ethane: | 150 | ppm |
| Ethylene: | 150 | ppm |
| Propane: | 70 | ppm |
| CO: | 1300 | ppm |

| | |
|---|---|
| O2: | 10% |
| Balance: | He |

and a space velocity of 50 000 h⁻¹ was applied (FIG. 5).

### Example 6

Table 1 shows the catalytic activity of activated La_{0.9}Ce_{0.1}CoO₃ on ceramic substrate. The catalyst in powder form was prepared as described in Example 1 (Sample C—Invention Method). The catalyst powder (75%) was mixed to 25% other washcoat additives, such as, alumina, ceria, ceria-zirconia and coated on a ceramic substrate with a loading level of 2.6 g/in³. The gas composition was the same as specified in Example 3 and a space velocity of 30000 h⁻¹ was applied.

TABLE 1

| T (° C.) | CO conversion (%) |
|---|---|
| 150 | 20 |
| 175 | 47 |
| 225 | 74 |
| 400 | 99 |

### Example 7

Table 2 shows the catalytic activity of activated La_{0.9}Ce_{0.1}CoO₃ on a metallic substrate. The catalyst in powder form was prepared as described in Example 1 (Sample C—Invention Method). The catalyst powder (75%) was mixed to 25% other washcoat additives and coated on a metallic substrate with a loading level of 2.5 g/in³. The gas composition used in this example was:

| | |
|---|---|
| C₃H₆: | 200 ppm |
| CO: | 2000 ppm |
| O₂: | 20% |
| H₂O: | 10% |
| N2: | balance |

and a space velocity of 100,000 h⁻¹ was applied.

TABLE 2

| T (° C.) | CO conversion (%) |
|---|---|
| 197 | 40 |
| 246 | 63 |
| 312 | 86 |
| 355 | 97 |

### Example 8

An activated catalyst in powder form was prepared as described in Example 1 (Sample C—Invention Method). The catalyst powder (75%) was mixed to 25% alumina and coated on a ceramic substrate with a loading level of 2.5 g/in³. The loaded monolith was calcined at 450° C. for 3 hours and subjected to the ultrasonic vibration in ethanol media for 8 minutes. The weight lost after an adhesion test was recorded at less than 4%.

Numerous modifications could be made to any of the embodiments above without departing from the scope of the present invention as defined in the appended claims.

1. A process for producing an activated perovskite-based catalyst washcoat formulation suitable for reduction of CO, VOC, PM and NOx emissions from an exhaust gas stream, said process comprising the steps of:
a) subjecting a fully synthesized perovskite structure to high energy ball milling to provide an activated nanocrystalline perovskite in powder form, said activated nanocrystalline perovskite having a given surface area;
b) mixing said activated nanocrystalline perovskite in powder form with dispersing media to produce a mixture and grinding said mixture for dispersing said activated nanocrystalline perovskite in said dispersing media;
c) removing partially or totally said dispersing media by a chemical or a physical method so as to obtain said activated perovskite-based catalyst washcoat formulation, said activated perovskite-based catalyst washcoat formulation containing an activated perovskite having an increased specific surface area relative to said given surface area of the activated nanocrystalline perovskite obtained in step a).

2. A process according to claim 1, comprising, before step a), an additional step of: providing an intimate mixture of starting precursors suitable for synthesis of perovskite and subjecting said mixture to high temperature heat treatment to obtain said fully synthesized perovskite structure.

3. A process according to claim 2, wherein said mixture of starting precursors is provided by co-precipitation, citrate method, sol-gel method, or ball milling of oxide ingredients.

4. A process according to claim 2, wherein the high temperature heat treatment of said mixture of starting precursors is performed under air and at temperatures between 700 and 1200° C.

5. A process according to claim 1, wherein step a) of high energy ball milling is performed with a horizontal high energy ball mill.

6. A process according to claim 5, wherein the horizontal high energy ball mill is operating at a speed in the range of 50 to 1000 rpm for a period of time ranging from 1 to 7 hours.

7. A process according to claim 1, wherein the grinding in step b) is performed with a vertical high energy ball mill.

8. A process according to claim 7, wherein said grinding step occurs over a period of time ranging from 3 to 10 hours.

9. A process according to claim 1, wherein step a) and step b) are combined and the operation is performed with a vertical high energy ball mill.

10. A process according to claim 9, wherein said high energy ball milling and grinding step occurs over a period of time ranging from 3 to 10 hours.

11. A process according to claim 7, wherein the vertical high energy ball mill is operating at a speed in the range of 150 to 500 rpm.

12. A process according to claim 1, wherein at least one additive is added in step a) of high energy ball milling, the at least one additive being CeO₂, AI₂O₃, SiO₂, V₂O₃, B2O3, ZrO₂, Y₂O₃, or stabilized ZrO₂, or any combination thereof.

13. A process according to claim 12, wherein the dispersing media is water.

14. A process according to claim 12, wherein the dispersing media is a combination of water and triethanolamine (TEA).

15. A process according to claim 1, wherein the dispersing media is 5 to 60 wt. % of the total charge.

16. A process according to claim 1, wherein the dispersing media is partially removed by subsequent drying and calcination steps.

17. A process according to claim 1, comprising, after step c), a step of:
d) applying said activated perovskite-based catalyst washcoat formulation on a metallic or ceramic substrate to obtain a perovskite-based catalytic converter.

18. An activated perovskite-based catalyst washcoat formulation obtained according to the process defined in claim 1, wherein said increased specific surface area varies between 10 and 200 m²/g.

19. An activated perovskite-based catalyst washcoat formulation according to claim 18, having a catalytic activity to convert CO to CO₂, in the presence of oxygen, at a temperature lower than 150° C.

20. A perovskite-based catalytic converter obtained according to the process defined in claim 17.

21. A perovskite-based catalytic converter according to claim 20, comprising a support structure covered with an activated perovskite-based catalyst washcoat formulation as defined in any one of claims 18 and 19.

22. A perovskite-based catalytic converter according to claim 21, wherein said activated perovskite-based catalyst washcoat formulation is wash coated on the support structure.

23. A perovskite-based catalytic converter according to claim 22, wherein the support structure is a ceramic or a metallic honeycomb.

24. Use of a perovskite-based catalytic converter as defined in claim 21 for catalytic reduction of emissions from a diesel engine exhaust gas stream.

25. Use of a perovskite-based catalytic converter as defined in claim 21 for catalytic conversion of VOC, methane, NOx or PM, or of any combination thereof.

26. An activated nanocrystalline perovskite in powder form, said activated nanocrystalline having a general chemical composition represented by the general formula:
A₁₋ₓA′ₓB_{1-(y+z)}B′_{1-y}M_{z}O₃
where A is La, Sr, Pr, Gd or Sm and A′ is a substitution element selected from the group of elements consisting of Ca, K, Ba, Sr, Ce, Pr, Mg, Li and Na; B and B′ are tetravalent, divalent or monovalent cations selected from the group of elements consisting of Co, Mn, Cu, Fe, Ti, Ni, Zn, Cr, V, Ga, Sn, Y, Zr, Nb, Mo, Ag, Au and Ge;
M is selected from the group of platinum metals consisting of Ru, Rh, Pd, Os, ]r, and Pt;
and X and Y vary between 0 and 0.5 and Z varies between 0 and 0.1;
having a catalytic activity to convert CO to CO₂, in the presence of oxygen, at a temperature of 150° C.; and
wherein said activated nanocrystalline perovskite is a powder obtained by subjecting a fully synthesized perovskite structure to high energy ball milling.

27. An activated nanocrystalline perovskite according to claim 26, having a chemical composition of Lao,6Sro.4Coo.99Mo.o103., where M is an element from the group of platinum metals.

28. An activated nanocrystalline perovskite according to claim 26, in a powder form having a mean crystallite size, obtained from X-ray diffraction method, of less than 100 nm.

29. An activated nanocrystalline perovskite according to claim 26, in powder form having a particle size ranging from 0.04 to 100 microns obtained by laser diffraction method.
